(19) United States
(12) Patent Application Publication
(10) Pub. No.: US 2015/0360306 A1
(43) Pub. Date: Dec. 17, 2015

(54) Filing Tool Attachment for a Reciprocating Tool

(71) Applicant: Philip Reisler, Gambrills, MD (US)

(72) Inventor: Philip Reisler, Gambrills, MD (US)

(21) Appl. No.: 14/733,137

(22) Filed: Jun. 8, 2015

Related U.S. Application Data
(60) Provisional application No. 62/010,523, filed on Jun. 11, 2014.

(51) Int. Cl. B23D 67/04

(52) U.S. Cl. CPC B23D 67/04

(57) ABSTRACT

A filing tool attachment for a reciprocating tool is provided. The filing tool attachment includes an elongated bar having a first end, a body, and a second end. The bar includes a plurality of grooved teeth along the length of the body of the elongated bar. The first end of the elongated bar includes a locking mechanism at a first end of the elongated bar adapted to securably attach the filing tool to a reciprocating tool head. The filing tool attachment provides an attachable accessory for a reciprocating tool without the need for adapters.

### CROSS REFERENCE TO RELATED APPLICATION

This application claims the benefit of U.S. Provisional Application No. 62/010,523 filed on Jun. 11, 2014. The above identified patent application is herein incorporated by reference in its entirety to provide continuity of disclosure.

### BACKGROUND OF THE INVENTION

### Field of the Invention

The present invention generally relates to a tool attachment for power tool. More specifically, the present invention relates to a filing tool attachment for a reciprocating tool comprising an elongated bar having a first end with a locking mechanism adapted to securably attach to a reciprocating tool such that filing tool is driven by the motor of the reciprocating tool.

Hand filing involves intense manual labor and workman skills. The teeth of a hand file are formed so as to cut only during a forward pushing motion during which downward pressure against the work piece must be applied. If the correct amount of pressure is not applied, especially on hard materials, the movement tends to dull the teeth quickly. Conversely, applying too much pressure to the hand file tends to clog the teeth and break them off. It can be time very consuming and difficult for craftsmen to file objects down by hand. Additionally, when filing down different materials, an individual must switch from one file to another type of file, which can waste even more time. It can also be a hassle to transport these different tools from worksite to worksite. Therefore, there exists a need for an efficient means for easily adding or removing a file from a device.

The present invention contemplates a filing tool attachment that affixes to a reciprocating tool head such as a reciprocating saw or other elongated, handheld tool, whereby the reciprocating tool rapidly moves the filing attachment back and forth attached s supports sheet material along the upper end of the tool. Specifically, the filing tool attachment is attached within the tool receiving end of a reciprocating tool such that it creates friction with the treated surface for sanding with precise control over the file.

Many variations are contemplated, including a multitude of different filing attachments being attached to the reciprocating tool, such as mill files, joint round edge files, half-round files, needle files, and machine files, among others. It is not desired to limit the type of filing attachment that can be utilized nor is it desired to limit the specific type of reciprocating tool in connection with the device. Rather, it is desired to disclose a new and novel filing attachment for reciprocating tools that include a first end that can be securably be attached to a tool head.

### SUMMARY OF THE INVENTION

In view of the foregoing disadvantages inherent in the known types of filing tools now present in the prior art, the present invention provides a filing tool attachment wherein the same can be utilized for providing convenience for the user when filing an object using a reciprocating tool.

It is therefore an object of the present invention to provide a filing tool attachment for reciprocating tools that allows blades, sanders, or any other device associated with a reciprocating tool to be quickly interchanged. The filing tool attachment comprises an elongated bar having a first end, a body, and a second end. The elongated bar includes a plurality of grooved teeth along the length of the body of the elongated bar. The first end of the elongated bar includes a locking mechanism adapted to securably attach the filing tool to a reciprocating tool.

It is another object of the present invention to provide a filing tool attachment for reciprocating tools having an elongated body having a front face and a rear face, wherein each face includes a plurality of grooved teeth configured to engage and cut material from a work piece. The cross sectional area of the bar varies in width in order to present a toothed surface, and provides a coarseness for each of the teeth. Each side of the filling tool attachment can be flat, round, half-round, triangular or rectangular, and the tooth configuration can coarse cut, bastard cut, single cut, double cut etc.

Another object of the present invention to provide a filing tool attachment for reciprocating tools wherein the first end of the elongated bar tapers to the locking mechanism. The locking mechanism is disposed on the first end of the elongated bar, wherein the locking mechanism is adapted to securably attach to a reciprocating tool. The locking mechanism forms a curved end that is configured to hook onto the chuck of a reciprocating tool.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of the filing tool attachment according to one embodiment of the present invention.

FIG. 2 shows a front view of the filing tool attachment according to another embodiment of the present invention.

FIG. 3 shows the filing tool attachment attached to a reciprocating tool according to one embodiment of the present invention.

### DETAILED DESCRIPTION OF THE INVENTION

Reference is made herein to the attached drawings. Like reference numerals are used throughout the drawings to depict like or similar elements of the filing tool attachment. For the purposes of presenting a brief and clear description of the present invention, the preferred embodiment will be discussed as used for filing objects by attaching the filing tool to a reciprocating tool. The figures are intended for representative purposes only and should not be considered to be limiting in any respect.

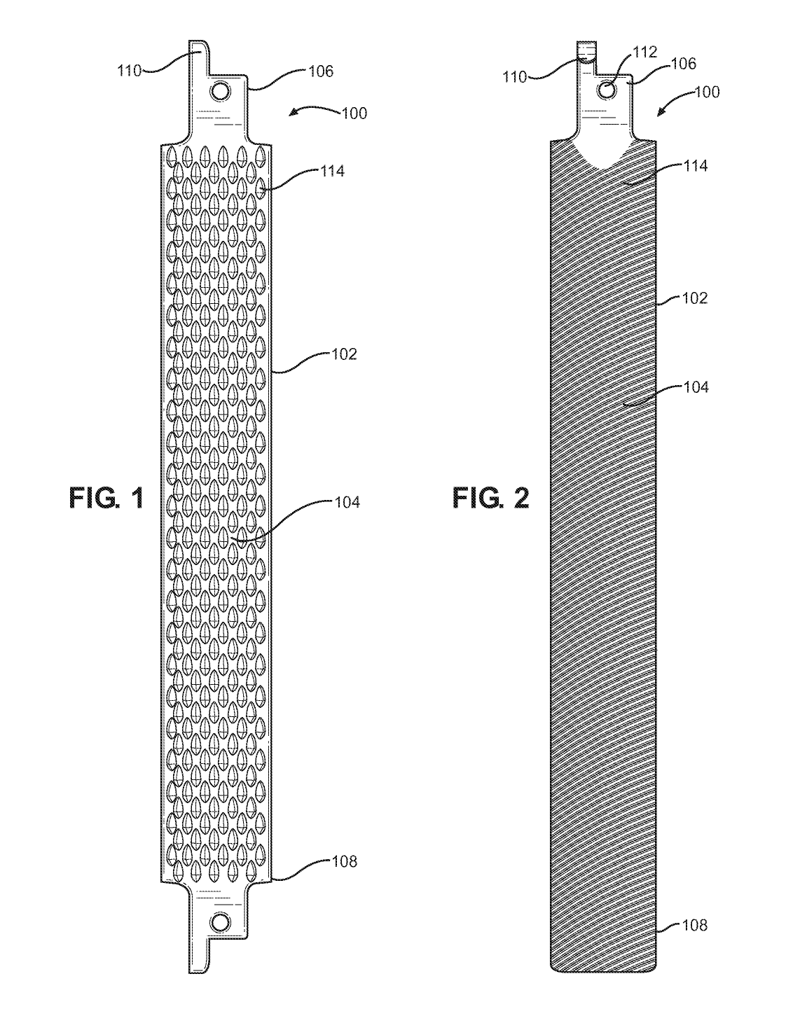

Referring now to FIG. 1, there is shown a rear view of the filing tool attachment for reciprocating tools according to one embodiment of the present invention. The present invention concerns a filing tool attachment 100 that comprises an elongated bar 102 with a front face and a rear face, wherein the front face and the rear face comprises a plurality of teeth 114 adapted to engage and cut material from a work piece. The cross sectional area of the bar 102 varies in width in order to have a toothed surface at different sections along the bar 102, as well as the coarseness and number of teeth. For example, each side of the files can be flat, round, half-round, triangular or rectangular, and the tooth configuration can coarse cut, bastard cut, single cut, double cut, etc.

In some embodiments, the filing too attachment 100 may be a rasp file with an arrangement of round cupped teeth. It is to be understood therefore that this invention relates to all variations of files, wherein these variation of files all have a common characteristic comprising an elongated bar 102 body of hardened steel having a first end 106 with a tapered hook 110 extending from the first end 106 thereof. Additionally, the elongated bar 102 includes a second end 108 having a spiked end. It is this common hand file with which this invention is particularly concerned, it being an object of this invention to modify such a file and thereby adapt it to a chuck of a reciprocating power tool.

Referring now to FIG. 2, there is shown a front view of the filing tool attachment for reciprocating tools according to another embodiment of the present invention. The filing tool attachment 100 includes an elongated bar 102 having a body 104, a first end 106 and a second end 108. The present invention provides an easy, quick, and efficient means for filing down various metals, wood, plastics, or other materials. The body 104 of the elongated bar 102 is preferably composed of a steel bar with a case hardened front and rear surface. In this embodiment, the body 104 includes a plurality of grooved teeth 114 disposed along the length of the body, wherein the teeth 114 are arranged as a series of sharp, parallel teeth. The teeth 114 on the body 104 can comprise a plurality of cuts, such as rough, middle, bastard, second cut, smooth, and dead smooth. The filing tool attachment 100 further includes a second end 108 of different grits or roughness, such as a rounded end, a spiked end, or a flat end, thereby accommodating the needs of an individual and the task at hand.

The first end 106 of the elongated bar 102 tapers towards the locking mechanism 110. The locking mechanism 110 is disposed on the first end 106 of the elongated bar 102, wherein the locking mechanism 110 is adapted to securably attach to a reciprocating tool. The locking mechanism 110 forms a curved end that is configured to hook onto the chuck of a reciprocating tool. The first end 106 further includes an aperture 112 adapted to receive a tool bit. In this way, the filling attachment 100 is coupled to a tool head that allows reciprocating filing on a flat surface where work pieces are fed into the file. The file teeth are angled so that material is removed on each down stroke of the tool.

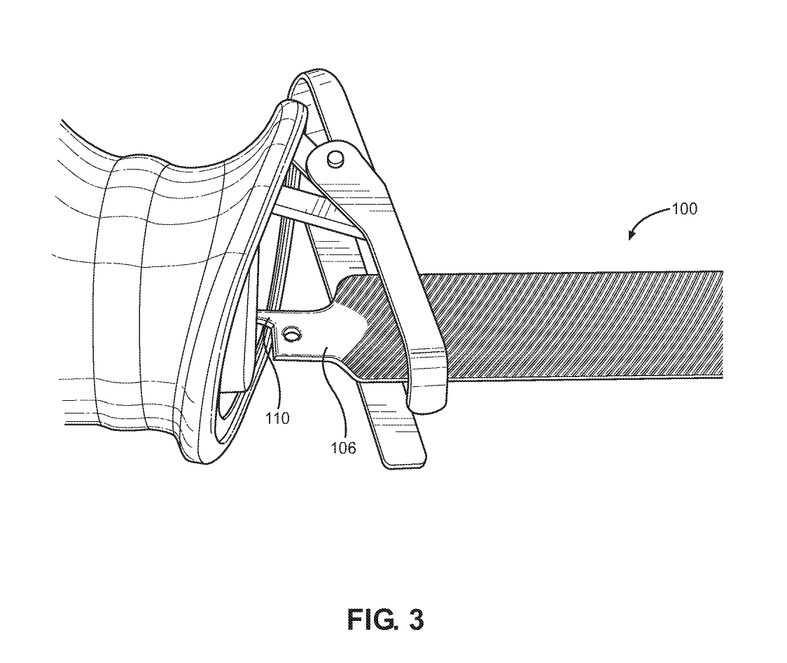

Referring now to FIG. 3, there is shown the filing tool attachment attached to a reciprocating tool according to one embodiment of the present invention. In use, the file tool attachment 100 is inserted into a reciprocating tool and removably secured thereto via the locking mechanism 110 on the first end 106. The illustrated embodiment shows a view of a half-flat file of the present invention inserted into the reciprocating tool. The filing tool attachment can comprise a plurality of different configurations wherein the tool can be removably attached to a reciprocating tool without the need for adapters. A wide range of files can be offered, including a flat file, half-flat file, half-rounded file, and a spiked file. The files of the present invention can be adapted for use on pipes, wood, and/or steel more efficiently and quicker than manual means. Further, the present invention can be utilized for filing or cutting drywall and smoothing out metal, steel, and copper. In this way, the present invention provides a device that allows users to file down an uneven cut on various materials, thereby saving a significant amount of time and frustration.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A filing tool attachment, comprising:
an elongated bar having a body, a first end and a second end, wherein a plurality of grooved teeth are disposed along a length of the body of the elongated bar;
a locking mechanism is disposed on the first end of elongated bar, wherein the locking mechanism is adapted to securably attach to a reciprocating tool.

2. The filing tool attachment of claim 1, wherein the filing member is a half-flat file having a front face and a rear face, wherein the front face and the rear face each includes a plurality of teeth thereon.

3. The filing tool attachment of claim 1, wherein the elongated bar further comprises a front face and a rear face, wherein the front face is flat and the rear face is rounded.

4. The filing tool attachment of claim 1, wherein the filing member further comprises a substantially rounded body.

5. The filing tool attachment of claim 1, wherein the second end of the filing member includes a spike.

6. The filing tool attachment of claim 1, wherein the first end of the filing member tapers to the locking mechanism.

7. The filing tool attachment of claim 6, wherein the locking mechanism is hook portion.

8. The filing tool attachment of claim 1, wherein the first end further includes an aperture adapted to receive a tool bit.
